(19) United States
(12) Patent Application Publication
(10) Pub. No.: US 2026/0299252 A1
(43) Pub. Date: Oct. 1, 2026

(54) OPTICAL APPARATUS

(71) Applicant: CANON KABUSHIKI KAISHA, Tokyo (JP)

(72) Inventor: KOHEI UEMURA, Tokyo (JP)

(21) Appl. No.: 19/550,904

(22) Filed: Feb. 26, 2026

(30) Foreign Application Priority Data
Mar. 26, 2025 (JP) 2025-051954

(51) Int. Cl. G02B 7/10; G02B 7/02; G02B 15/14; G03B 17/12

(52) U.S. Cl. CPC G02B 7/10; G02B 7/021; G02B 7/023; G02B 15/143; G03B 17/12; G03B 2205/0046; G03B 2205/0069

(57) ABSTRACT

An optical apparatus includes a first support member that supports a first optical member so as to be movable in an optical-axis direction, a second support member that supports a second optical member so as to be movable in the optical-axis direction, and a third support member that supports a third optical member so as to be movable in the optical-axis direction. The first support member restricts a position of the second optical member within a plane orthogonal to an optical axis. The third support member restricts a position of the first optical member within a plane orthogonal to the optical axis.

### BACKGROUND

### Field of the Technology

The present disclosure relates to an optical apparatus.

### Description of the Related Art

Japanese Patent Applications Laid-Open Nos. 2010-8658 and 2013-15591 disclose a lens apparatus that includes a lens unit movable in an optical-axis direction by an actuator.

In a configuration in which three or more lens units are independently movable in the optical-axis direction, arranging three or more actuators in the optical-axis direction may increase the size of the optical apparatus.

### SUMMARY

An optical apparatus according to one aspect of the present disclosure may include a first support member that supports a first optical member so as to be movable in an optical-axis direction, a second support member that supports a second optical member so as to be movable in the optical-axis direction, and a third support member that supports a third optical member so as to be movable in the optical-axis direction. The first support member restricts a position of the second optical member within a plane orthogonal to an optical axis. The third support member restricts a position of the first optical member within a plane orthogonal to the optical axis.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of an image pickup system according to the present embodiment.

FIG. 2 is a block diagram of an image pickup system according to the present embodiment.

FIG. 3 is a sectional view of the image pickup system at a wide-angle (WIDE) end according to the present embodiment.

FIG. 4 is a sectional view of the image pickup system at a telephoto (TELE) end according to the present embodiment.

FIG. 5 is an exploded perspective view of a lens apparatus according to the present embodiment.

FIG. 6 illustrates a first zoom unit viewed from a first-unit side in an optical-axis direction according to the present embodiment.

FIG. 7 is a perspective view illustrating a relationship among the first zoom unit, a second zoom unit, and a first guide bar according to the present embodiment.

FIG. 8 illustrates the second zoom unit viewed from the first-unit side in the optical-axis direction according to the present embodiment.

FIG. 9 is a perspective view illustrating a relationship among the second zoom unit, a focus unit, and a second guide bar according to the present embodiment.

FIG. 10 illustrates the focus unit when viewed from the first-unit side in the optical-axis direction according to the present embodiment.

FIG. 11 is a perspective view illustrating a relationship among the focus unit, the first zoom unit, and a third guide bar according to the present embodiment.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted. The present embodiment will discuss an interchangeable lens, which is one example of an optical apparatus, but the present disclosure is not limited to this embodiment, and various modifications and changes are possible within the scope of the gist of the present disclosure, such as application to a lens-integrated camera.

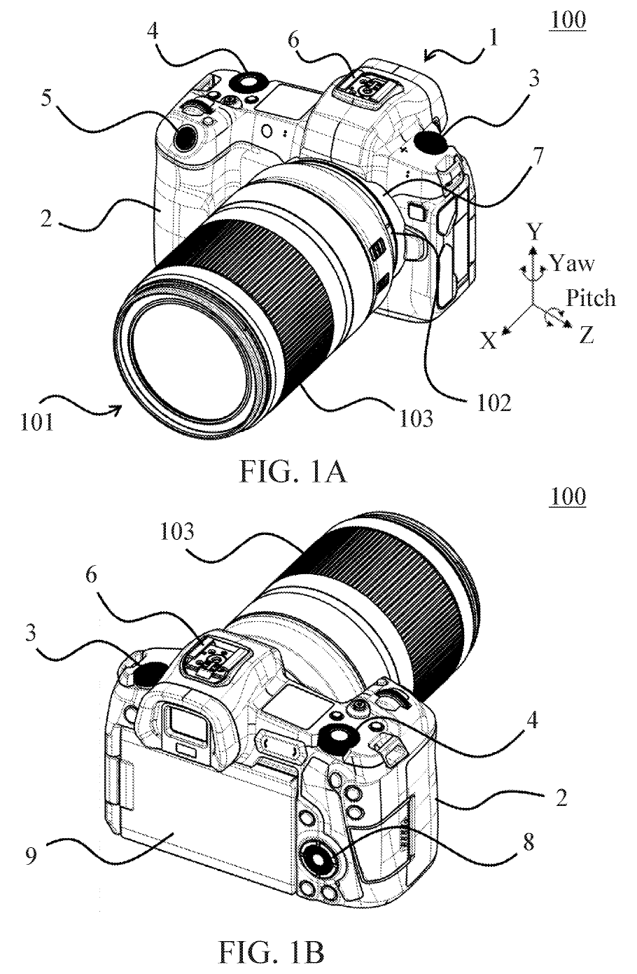

FIGS. 1A and 1B are external views of an imaging system (camera system) 100 according to the present embodiment. FIG. 1A is a perspective view of the imaging system 100 viewed from the front side, and FIG. 1B is a perspective view of the imaging system 100 viewed from the rear side. The imaging system 100 includes a camera body (image pickup apparatus) 1 and a lens apparatus (interchangeable lens, optical apparatus) 101 that is detachably attached to the camera body 1. However, the present embodiment is not limited to this example, and the present disclosure is also applicable to an image pickup apparatus in which the camera body and the lens apparatus are integrated.

As illustrated in FIG. 1A, an optical-axis direction in which the optical axis of an imaging optical system housed in the lens apparatus 101 extends will be defined as an X-axis direction, and directions orthogonal thereto will be defined as a Z-axis direction (horizontal direction) and a Y-axis direction (vertical direction). Hereinafter, the Z-axis direction and the Y-axis direction will also be collectively referred to as a Z/Y-axis direction. A rotational direction about the Z-axis will be defined as a pitch direction, and a rotational direction about the Y-axis will be defined as a yaw direction. The pitch direction and the yaw direction (hereinafter also collectively referred to as pitch/yaw directions) are rotational directions about two axes, namely the Z-axis and the Y-axis, which are orthogonal to each other.

On the left side of the camera body 1 when viewed from the front (the right side when viewed from the rear), a grip portion 2 is provided for a user to hold the camera body 1 by hand. On an upper surface of the camera body 1, a power operation unit 3 is disposed. When the user operates the power operation unit 3 to turn it on while the camera body 1 is in a power-off state, the camera body 1 enters a power-on state and imaging becomes possible. When the user operates the power operation unit 3 to turn it off while the camera body 1 is in the power-on state, the camera body 1 enters the power-off state.

A mode dial 4, a release button 5, and an accessory shoe 6 are provided on the upper surface of the camera body 1. By rotating the mode dial 4, the user can switch an imaging mode. The imaging modes include a manual still image capturing mode in which an imaging condition such as a shutter speed and an aperture value (F-number) can be arbitrarily set by the user, an automatic still image capturing mode in which a proper exposure amount is automatically obtained, and a moving image capturing mode for capturing a moving image. When the user half-presses the release button 5, an imaging preparation operation such as autofocus (AF) and auto-exposure (AE) control can be instructed, and when the user fully presses the release button 5, imaging can be instructed. An accessory such as an external flash or an external viewfinder (EVF), not illustrated, can be detachably attached to the accessory shoe 6. An image sensor for photoelectrically converting (capturing) an object image formed by the imaging optical system in the lens apparatus 101 is provided inside the camera body 1.

The lens apparatus 101 is mechanically and electrically connected to a camera mount 7 provided on the camera body 1 via a lens mount 102. As described above, the lens apparatus 101 houses the imaging optical system that forms an object image by imaging light from an object. A zoom operation ring (zoom operation member) 103 that is rotatable about the optical axis by a user operation is provided on an outer circumference of the lens apparatus 101. A knurled shape is formed on an outer circumferential portion of the zoom operation ring 103 to prevent the user's hand from slipping during operation. When the zoom operation ring 103 is rotated by the user, a zoom unit constituting the imaging optical system moves in optical position in accordance with the operation of the zoom operation ring 103. Details of the operation of the zoom operation ring will be described later. By operating the zoom operation ring, the user can capture an image at a desired angle of view.

As illustrated in FIG. 1B, a rear operation unit 8 and a display unit 9 are provided on a rear surface of the camera body 1. The rear operation unit 8 includes a plurality of buttons and dials to which a variety of functions are assigned. When the camera body 1 is in the power-on state and a still or moving image capturing mode is set, a through-image (live-view image) of an object image being captured by the image sensor is displayed on the display unit 9. The display unit 9 also displays an imaging parameter such as a shutter speed and an aperture value, and the user can change a set value of the imaging parameter by operating the rear operation unit 8 while viewing the display. The rear operation unit 8 includes a playback button for instructing playback of a recorded captured image, and when the user operates the playback button, the captured image is played back and displayed on the display unit 9.

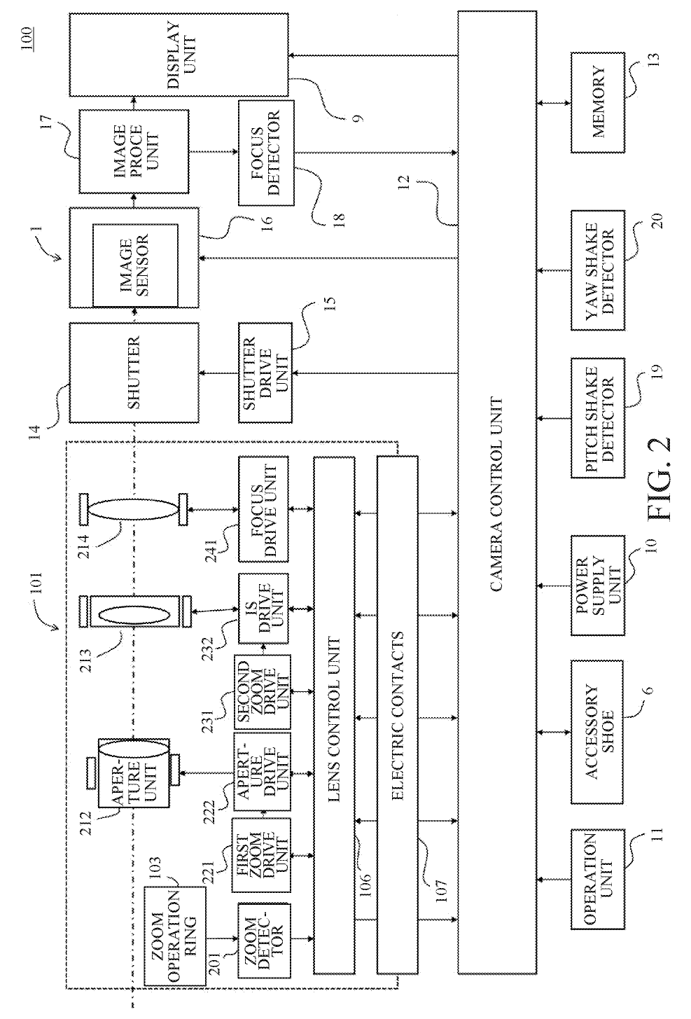

FIG. 2 is a block diagram illustrating an electrical and optical configuration of the imaging system 100 constituted by the lens apparatus 101 and the camera body 1. The camera body 1 includes a power supply unit 10 that supplies power to the camera body 1 and the lens apparatus 101, and an operation unit 11 including the power operation unit 3, the mode dial 4, the release button 5, the rear operation unit 8, and a touch panel function of the display unit 9. Overall system control of the camera body 1 and the lens apparatus 101 is performed through cooperation between a camera control unit 12 provided in the camera body 1 and a lens control unit 106 provided in the lens apparatus 101. The camera control unit 12 reads and executes a computer program stored in a memory 13. At that time, the camera control unit 12 communicates various control signals and data with the lens control unit 106 via communication terminals of electrical contacts 107 provided on the lens mount 102. The electrical contacts 107 include power supply terminals for supplying power from the power supply unit 10 to the lens apparatus 101.

The imaging optical system in the lens apparatus 101 includes a first zoom unit (zoom lens, first optical member) 212 and a second zoom unit (second optical member) 213, which move in the optical-axis direction to change the angle of view. The first zoom unit 212 includes an aperture unit (aperture stop, diaphragm) that performs a light amount adjustment operation. The second zoom unit 213 includes an image stabilizing unit having a shift lens as an image stabilizing element for reducing image blur. The image stabilizing unit performs an image stabilization operation by shifting the shift lens in the Z/Y-axis direction orthogonal to the optical axis to reduce image blur. A focus unit 214 includes a focus lens (third optical member) that moves in the optical-axis direction to perform focusing.

The lens apparatus 101 further includes a first zoom drive unit (first drive unit) 221, a second zoom drive unit (second drive unit) 231, and a focus drive unit (third drive unit) 241. The first zoom drive unit 221 drives the first zoom unit 212 in the optical-axis direction. The second zoom drive unit 231 drives the second zoom unit 213 in the optical-axis direction. The focus drive unit 241 drives the focus unit 214 to move the focus lens in the optical-axis direction. In the present embodiment, the first zoom drive unit 221, the second zoom drive unit 231, and the focus drive unit 241 may be linear actuators. The linear actuators may be vibration wave motors or voice coil motors.

The lens apparatus 101 further includes an aperture drive unit 222 and an image-stabilization (IS) drive unit 232. The aperture drive unit 222 drives the aperture unit of the first zoom unit 212. The image-stabilization drive unit 232 drives the image stabilizing unit of the second zoom unit 213 to shift the shift lens.

The camera body 1 includes a shutter unit 14, a shutter drive unit 15, an image sensor 16, an image processing unit 17, and the camera control unit 12 described above. The shutter unit 14 controls an amount of light that is collected by the imaging optical system in the lens apparatus 101 and exposed on the image sensor 16. The image sensor 16 photoelectrically converts an object image formed by the imaging optical system and outputs an imaging signal. The image processing unit 17 performs various image processing operations on the imaging signal and then generates an image signal. The display unit 9 displays the image signal (through-image) output from the image processing unit 17, displays imaging parameters as described above, or plays back and displays captured images recorded in the memory 13 or a recording medium (not illustrated).

The camera control unit 12 controls driving of the first zoom unit (aperture unit) 212 and the shutter unit 14 via the aperture drive unit 222 and the shutter drive unit 15 in accordance with set values of an aperture value and a shutter speed received from the operation unit 11. The aperture unit includes an aperture member including a plurality of aperture blade members for forming an arbitrary aperture diameter, and an aperture rotation member that rotates about an optical axis center and drives the aperture blade members. By interlocking the aperture drive unit 222 and the aperture rotation member, an arbitrary aperture diameter is formed to control a light amount.

The camera control unit 12 controls driving of the focus unit 214 according to the imaging preparation operation (half-press operation) of the release button 5 of the operation unit 11. For example, when an AF operation is instructed, a focus detector 18 determines a focus state of an object image formed on the image sensor 16 based on an image signal generated by the image processing unit 17, generates a focus signal, and transmits the focus signal to the camera control unit 12. At the same time, the focus drive unit 241 detects a current position of the focus unit 214 and transmits the detected position to the camera control unit 12 via the lens control unit 106. The camera control unit 12 compares the focus state of the object image with the current position of the focus unit 214, calculates a focus drive amount based on a deviation therebetween, and transmits the calculated focus drive amount to the lens control unit 106. The lens control unit 106 then drives and controls the focus unit 214 via the focus drive unit 241 to a target position, thereby correcting a focus deviation of the object image.

In a case where an AE control operation is instructed, the camera control unit 12 receives a luminance signal generated by the image processing unit 17 and performs photometric calculation (light metering calculation). Based on the photometric calculation result, the camera control unit 12 controls driving of the aperture unit according to an imaging instruction operation (full-press operation) of the release button 5 of the operation unit 11. The camera control unit 12 also controls driving of the shutter unit 14 via the shutter drive unit 15 to perform the exposure processing by the image sensor 16.

The camera body 1 includes a pitch shake detector 19 and a yaw shake detector 20 as shake detectors capable of detecting image blur such as camera shake by a user. The pitch shake detector 19 and the yaw shake detector 20 respectively detect image blur in the pitch direction (rotational direction about the Z-axis) and the yaw direction (rotational direction about the Y-axis) using angular velocity sensors (vibration gyros), angular acceleration sensors, or the like, and output shake signals. The camera control unit 12 calculates a shift position of the image stabilizing unit (shift lens) in the Y-axis direction using a shake signal from the pitch shake detector 19. Similarly, the camera control unit 12 calculates a shift position of the image stabilizing unit in the Z-axis direction using a shake signal from the yaw shake detector 20. The camera control unit 12 then drives and controls the image stabilizing unit to a target position in accordance with the calculated shift positions in the pitch/yaw directions, thereby performing an image stabilization operation to reduce image blur during exposure or during display of a through-image.

The lens apparatus 101 includes a zoom operation ring 103 for changing an angle of view of the imaging optical system, and a zoom detector 201 for detecting an angle (position) of the zoom operation ring 103. The zoom detector 201 detects, as an absolute value, the angle of the zoom operation ring 103 operated by a user, and is configured using, for example, a resistive arc-shaped sensor. Information on the angle of view detected by the zoom detector 201 is transmitted to the lens control unit 106 and is reflected in various types of control performed by the camera control unit 12 described above. On the other hand, part of various types of information is recorded together with captured images in the memory 13 or a recording medium.

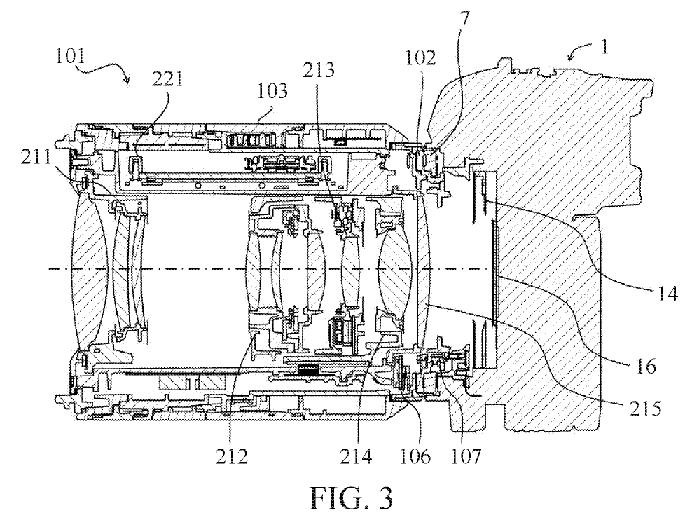

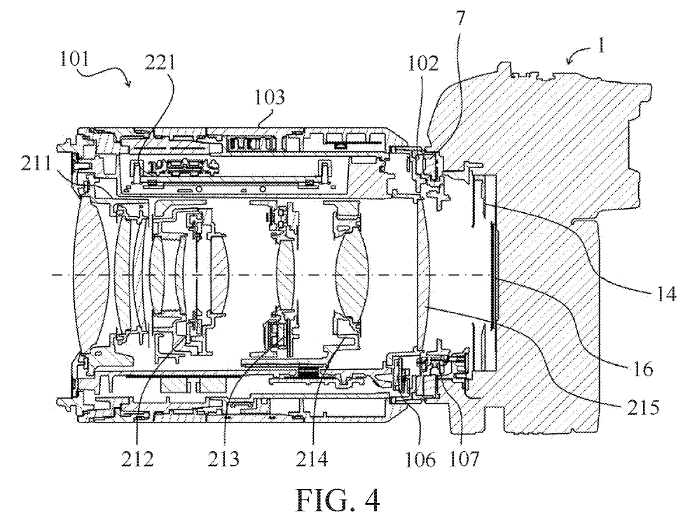

Next, positional relationships of constituent components in the lens apparatus 101 and the camera body 1 will be described with reference to FIGS. 3 and 4. FIGS. 3 and 4 are sectional views of the imaging system 100 on an XY plane including the optical axis. FIG. 3 illustrates a WIDE state (wide-angle end), and FIG. 4 illustrates a TELE state (telephoto end). Since a centerline illustrated therein approximately coincides with the optical axis determined by the imaging optical system, the centerline is hereinafter regarded as synonymous with the optical axis.

The present embodiment adopts a five-unit configuration as one example of the imaging optical system. Each zoom unit that has moved to a predetermined optical position corresponding to an angle of view forms an image of light from an object on an imaging surface of the image sensor 16. At this time, an aperture unit functions as the first zoom unit 212, and an image stabilizing unit functions as the second zoom unit 213. The imaging optical system includes a first unit 211 that is a fixed unit (fixed lens unit), a second unit (first zoom unit 212) that is an aperture unit, a third unit (second zoom unit 213) that is an image stabilizing unit, a fourth unit (focus unit 214), and a fifth unit 215 that is a fixed unit (fixed lens unit). However, the present embodiment does not limit the configuration of lens units. For example, the fifth unit 215 may be configured to function as a third zoom unit. In addition, some lens units may be fixed without being movable.

When the user rotates the zoom operation ring 103, the lens control unit 106 drives and controls the second unit (aperture unit, optical member) to a target position via the first zoom drive unit 221 based on angle-of-view information detected by the zoom detector 201, thereby moving the second unit 212 forward and backward in the optical-axis direction. The lens control unit 106 also drives and controls the third unit (image stabilizing unit) to a target position via the second zoom drive unit 231, thereby moving the third unit forward and backward in the optical-axis direction. Thereby, the user can perform imaging at a desired angle of view.

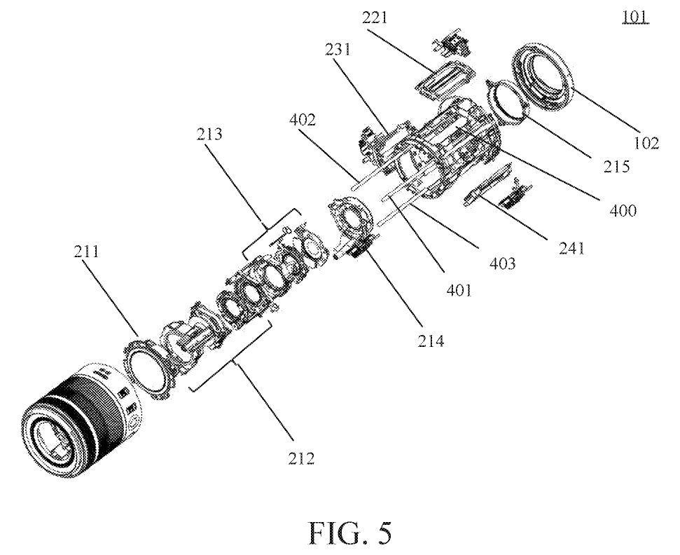

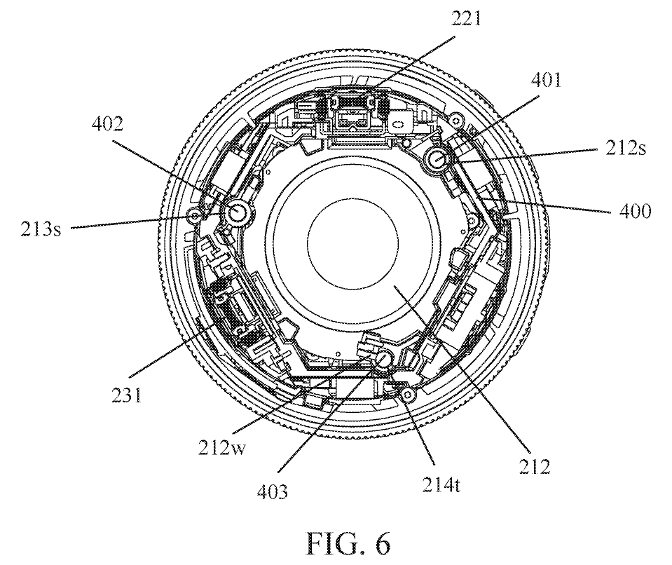

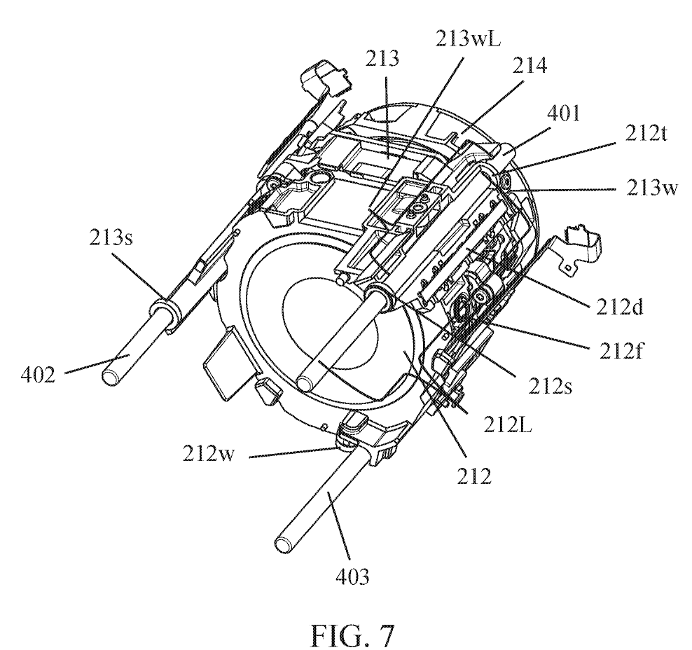

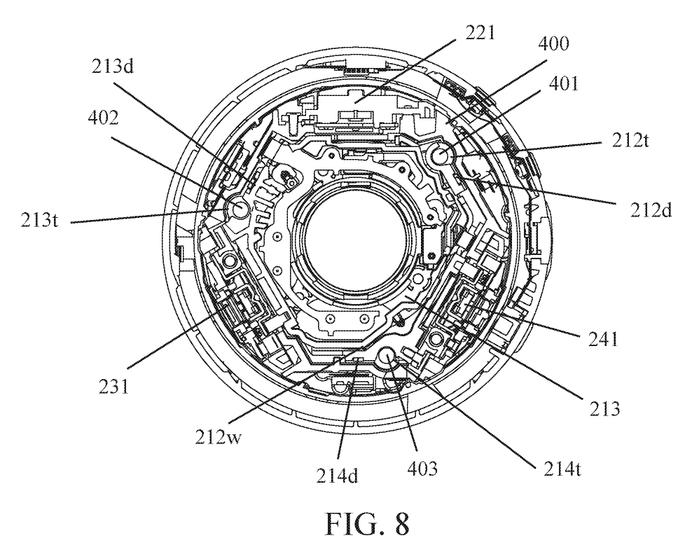

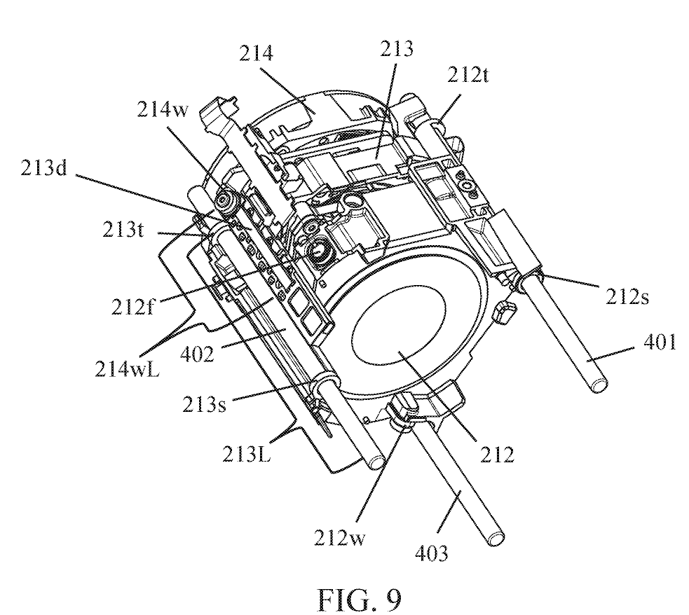

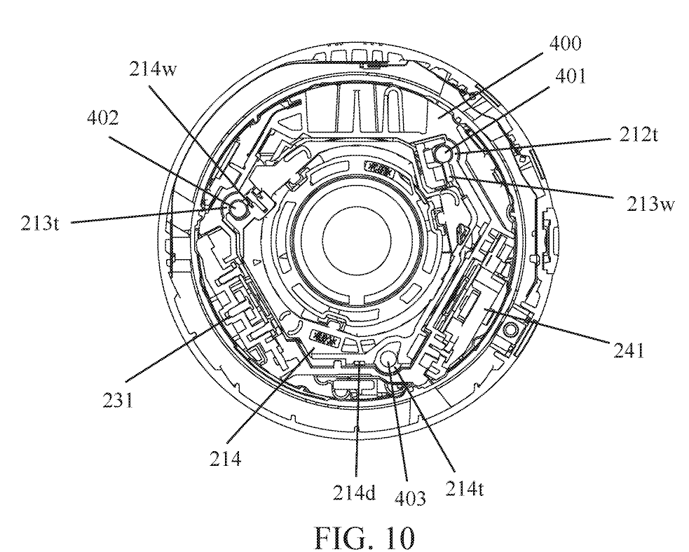

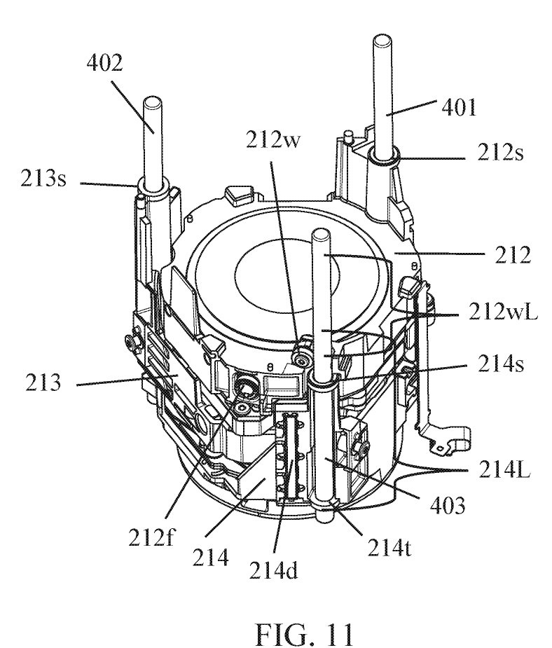

Next, the lens apparatus 101 will be described in detail with reference to FIGS. 5-11. FIG. 5 is an exploded perspective view of the lens apparatus 101, illustrating some elements in an exploded manner when viewed obliquely from the front. FIG. 6 illustrates the first zoom unit 212 when viewed from the first unit 211 side in the optical-axis direction. FIG. 7 is a perspective view illustrating a relationship among the first zoom unit 212, the second zoom unit 213, and a first guide bar (first support member) 401. FIG. 8 illustrates the second zoom unit 213 when viewed from the first unit 211 side in the optical-axis direction. FIG. 9 is a perspective view illustrating a relationship among the second zoom unit 213, the focus unit 214, and a second guide bar (second support member) 402. FIG. 10 illustrates the focus unit 214 when viewed from the first unit 211 side in the optical-axis direction. FIG. 11 is a perspective view illustrating a relationship among the focus unit 214, the first zoom unit 212, and a third guide bar (third support member) 403.

A fixed barrel 400 includes the first zoom drive unit 221, the second zoom drive unit 231, and the focus drive unit 241. On an outer circumferential portion of the fixed barrel 400, the three drive units are arranged in a well-balanced manner at equal angular intervals of approximately 120 degrees and at approximately the same distance from the optical axis. In the present embodiment, three drive units are provided; however, the number of drive units is not limited thereto. For example, when four drive units are provided, they may be arranged at intervals of approximately 90 degrees, and when five drive units are provided, they may be arranged at intervals of approximately 72 degrees.

In the present embodiment, at least parts of respective drive units are disposed so as to overlap each other in the optical-axis direction (i.e., to include a common position in the optical-axis direction). That is, at least a part of the first zoom drive unit 221, at least a part of the second zoom drive unit 231, and at least a part of the focus drive unit 241 are disposed within a predetermined plane orthogonal to the optical axis. This configuration can suppress an overall length (length in the optical-axis direction) of the lens apparatus 101.

50% or more of the overall length of each drive unit may overlap other drive units in the optical-axis direction. That is, half or more of the overall length of the first zoom drive unit 221 in the optical-axis direction overlaps each of the second zoom drive unit 231 and the focus drive unit 241 in the optical-axis direction. Similarly, half or more of the overall length of the second zoom drive unit 231 overlaps each of the first zoom drive unit 221 and the focus drive unit 241 in the optical-axis direction. Likewise, half or more of the overall length of the focus drive unit 241 overlaps each of the first zoom drive unit 221 and the second zoom drive unit 231 in the optical-axis direction. This configuration can enhance the effects.

In the present embodiment, the first zoom unit 212 is movable within a movement region (first region) 212L, the second zoom unit 213 is movable within a movement region (second region) 213L, and the focus unit 214 is movable within a movement region (third region) 214L. The movement regions 212L, 213L, and 214L include a common region in the optical-axis direction (i.e., include regions overlapping each other in the optical-axis direction). The present embodiment can support a lens arrangement in which parts of the movement region 212L of the first zoom unit 212, the movement region 213L of the second zoom unit 213, and the movement region 214L of the focus unit 214 overlap each other in the optical-axis direction.

Each drive unit is disposed closer to the optical axis in order to reduce the size of the lens apparatus 101, and is disposed so as to overlap the first unit 211 fixed to the fixed barrel 400, when viewed in the optical-axis direction. For example, at least a part of the first zoom drive unit 221 for driving the first zoom unit 212 adjacent to the first unit 211 overlaps the first unit 211 when viewed in the optical-axis direction. At least a part of each of the first zoom drive unit 221, the second zoom drive unit 231, and the focus drive unit 241 may overlap the first unit 211 when viewed in the optical-axis direction. This configuration can further reduce the size of the lens apparatus 101.

The first guide bar 401 holds the first zoom unit 212 so as to be movable in the optical-axis direction. The second guide bar 402 holds the second zoom unit 213 so as to be movable in the optical-axis direction. The third guide bar 403 holds the focus unit 214 so as to be movable in the optical-axis direction. One end of each of the first guide bar 401, the second guide bar 402, and the third guide bar 403 is held by the fixed barrel 400, and the other end is held by the first unit 211.

The first guide bar 401, the second guide bar 402, and the third guide bar 403 are disposed inside the fixed barrel 400 at approximately equal angular phases of approximately 120 degrees about the optical axis and at approximately the same distance from the optical axis. In the present embodiment, the number of guide bars is three; however, the number is not limited to this example. For example, in a case where four guide bars are provided, they may be arranged at approximately equal angular phases of approximately 90 degrees, and in a case where five guide bars are provided, they may be arranged at substantially equal angular phases of approximately 72 degrees. This configuration enables the movable lens units to be efficiently placed inside the fixed barrel 400, thereby facilitating size reduction.

A part of the first zoom unit 212 in a plane orthogonal to the optical axis (optical-axis-orthogonal plane) is restricted by the third guide bar 403. A part of the second zoom unit 213 in the optical-axis-orthogonal plane is restricted by the first guide bar 401. A part of the focus unit 214 in the optical-axis-orthogonal plane is restricted by the second guide bar 402.

In the present embodiment, the first guide bar 401 may restrict the position of the second zoom unit 213 in the optical-axis-orthogonal plane and the third guide bar 403 may restrict the position of the first zoom unit 212 in the optical-axis-orthogonal plane. In the present embodiment, the second guide bar 402 may restrict the position of the focus unit 214 in the optical-axis-orthogonal plane.

The first zoom unit 212 and the first guide bar 401 are engaged with each other by a first bearing portion 212s and a second bearing portion 212t. The second zoom unit 213 and the second guide bar 402 are engaged with each other by a first bearing portion 213s and a second bearing portion 213t. The focus unit 214 and the third guide bar 403 are engaged with each other by a first bearing portion 214s and a second bearing portion 214t. Bearings 212w, 213w, and 214w are provided as position restriction shape portions on the lens unit side in the optical-axis-orthogonal plane.

The first zoom unit 212 is fastened to the first zoom drive unit 221 by an unillustrated connecting member, and driving force of the first zoom drive unit 221 is transmitted to move the first zoom unit 212 in the optical-axis direction. The bearing 212w is urged toward the third guide bar 403 by an unillustrated elastic member provided in the first zoom drive unit 221.

The second zoom unit 213 is fastened to the second zoom drive unit 231 by an unillustrated connecting member, and driving force of the second zoom drive unit 231 is transmitted to move the second zoom unit 213 in the optical-axis direction. The bearing 213w is urged toward the first guide bar 401 by an unillustrated elastic member provided in the second zoom drive unit 231.

The focus unit 214 is fastened to the focus drive unit 241 by an unillustrated connecting member, and driving force of the focus drive unit 241 is transmitted to move the focus unit 214 in the optical-axis direction. The bearing 214w is urged toward the second guide bar 402 by an unillustrated elastic member provided in the focus drive unit 241.

The longer a distance in the optical-axis direction between each first bearing portion 212s, 213s, 214s and a corresponding second bearing portion 212t, 213t, 214t is, the higher positional accuracy of each movable lens unit becomes, and smoother operation can be achieved.

A first position detector 212d is provided on a side surface portion of a region sandwiched between the first zoom drive unit 221 and the focus drive unit 241, and detects a position (absolute position) of the first zoom unit 212 in the optical-axis direction. A second position detector 213d is provided on a side surface portion of a region sandwiched between the first zoom drive unit 221 and the second zoom drive unit 231, and detects a position (absolute position) of the second zoom unit 213 in the optical-axis direction. A third position detector 214d is provided on a side surface portion of a region sandwiched between the second zoom drive unit 231 and the focus drive unit 241, and detects a position (absolute position) of the focus unit 214 in the optical-axis direction.

Each of the first position detector 212d, the second position detector 213d, and the third position detector 214d is disposed between two adjacent drive units among a plurality of drive units including the first zoom drive unit 221, the second zoom drive unit 231, and the focus drive unit 241. For example, the first position detector 212d is disposed between the first zoom drive unit 221 and the focus drive unit 241. The second position detector 213d is disposed between the first zoom drive unit 221 and the second zoom drive unit 231, and the third position detector 214d is disposed between the second zoom drive unit 231 and the focus drive unit 241. Thereby, regions in which no drive units are disposed can be utilized as position detectors, and both size reduction of the lens apparatus 101 and smooth movement of the lens units can be achieved.

In the present embodiment, for each guide bar, one lens unit is held so as to be movable in the optical-axis direction, and one lens unit is restricted in position within the optical-axis-orthogonal plane.

As illustrated in FIG. 7, the bearing 213w does not require a length in the optical-axis direction, and therefore allows a movement region 212L of the first zoom unit 212 and a bearing movement region 213wL of the second zoom unit 213 on the first guide bar 401 to overlap each other. Thus, a distance in the optical-axis direction between the first bearing portion 212s and the second bearing portion 212t can be increased.

As illustrated in FIG. 9, the bearing 214w does not require a length in the optical-axis direction, and therefore allows a movement region 213L of the second zoom unit 213 and a bearing movement region 214wL of the focus unit 214 on the second guide bar 402 to overlap each other. Thus, a distance in the optical-axis direction between the first bearing portion 213s and the second bearing portion 213t can be increased.

As illustrated in FIG. 11, the bearing 212w does not require a length in the optical-axis direction, and therefore allows a movement region 214L of the focus unit 214 and a bearing movement region 212wL of the first zoom unit 212 on the third guide bar 403 to overlap each other. Thus, a distance in the optical-axis direction between the first bearing portion 214s and the second bearing portion 214t can be increased.

As described above, in the present embodiment, at least a part of the first zoom drive unit 221, at least a part of the second zoom drive unit 231, and at least a part of the focus drive unit 241 are disposed within a predetermined plane orthogonal to the optical axis. The first zoom drive unit 221, the second zoom drive unit 231, and the focus drive unit 241 may be arranged at mutually equal angular intervals around the optical axis when viewed in the optical-axis direction. The first zoom drive unit 221, the second zoom drive unit 231, and the focus drive unit 241 may be arranged such that distances from the optical axis are equal to each other when viewed in the optical-axis direction.

In the present embodiment, the number of sets each including an optical member, a drive unit, and a guide bar is not limited to three, and four or more such sets may be provided. In this case, the four or more drive units and guide bars may be arranged at approximately equal angular intervals around the optical axis when viewed in the optical-axis direction.

The present embodiment can provide a compact optical apparatus in which at least three lens units can smoothly move without degrading optical performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051954, filed on Mar. 26, 2025, which is hereby incorporated by reference herein in its entirety.

What is claimed is:

1. An optical apparatus comprising:
a first support member that supports a first optical member so as to be movable in an optical-axis direction;
a second support member that supports a second optical member so as to be movable in the optical-axis direction; and
a third support member that supports a third optical member so as to be movable in the optical-axis direction,
wherein the first support member restricts a position of the second optical member within a plane orthogonal to an optical axis, and
wherein the third support member restricts a position of the first optical member within a plane orthogonal to the optical axis.

2. The optical apparatus according to claim 1, wherein the second support member restricts a position of the third optical member within a plane orthogonal to the optical axis.

3. The optical apparatus according to claim 1, wherein the first optical member is movable within a first region,
wherein the second optical member is movable within a second region,
wherein the third optical member is movable within a third region, and
wherein the first region, the second region, and the third region include a common region in the optical-axis direction.

4. The optical apparatus according to claim 1, wherein the first support member, the second support member, and the third support member are arranged at mutually equal angular intervals around the optical axis when viewed in the optical-axis direction.

5. The optical apparatus according to claim 1, wherein the first support member, the second support member, and the third support member are arranged such that distances from the optical axis are equal to each other when viewed in the optical-axis direction.

6. The optical apparatus according to claim 1, further comprising:
a barrel; and
a fixed lens unit,
wherein, one end of each of the first support member, the second support member, and the third support member is held by the barrel and another end is held by the fixed lens unit.

7. The optical apparatus according to claim 1, further comprising:
a first drive unit configured to drive the first optical member in the optical-axis direction;
a second drive unit configured to drive the second optical member in the optical-axis direction; and
a third drive unit configured to drive the third optical member in the optical-axis direction,
wherein the first drive unit, the second drive unit, and the third drive unit are respectively disposed, when viewed in the optical-axis direction, in regions around the optical axis between adjacent two of the first support member, the second support member, and the third support member.

8. The optical apparatus according to claim 7, wherein each of the first drive unit, the second drive unit, and the third drive unit is a linear actuator.

9. The optical apparatus according to claim 8, wherein the linear actuator is a vibration wave motor or a voice coil motor.

10. The optical apparatus according to claim 1, wherein the first optical member is a first zoom unit,
wherein the second optical member is a second zoom unit, and
wherein the third optical member is a focus unit.
